(19) United States
(12) Patent Application Publication
(10) Pub. No.: US 2013/0122209 A1
(43) Pub. Date: May 16, 2013

(54) Organosilicon Hydrophobing Agents

(71) Applicant: Andreas Stammer, Pont-A-Celles (BE)

(72) Inventor: Andreas Stammer, Pont-A-Celles (BE)

(73) Assignee: DOW CORNING CORPORATION, Midland, MI (US)

(21) Appl. No.: 13/812,683

(22) PCT Filed: Jul. 21, 2011
(86) PCT No.: PCT/EP2011/062585

§ 371 Date: Jan. 28, 2013

(30) Foreign Application Priority Data
Jul. 28, 2010 (GB) GB 1012661.3

(51) Int. Cl. C09D 5/00

(52) U.S. Cl. CPC C09D 5/00
USPC 427/421.1; 106/287.13; 427/429; 427/428.01

(57) ABSTRACT

An organosilane having the formula

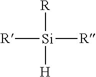

where R is an alkyl or cycloalkyl group having 4 to 30 carbon atoms comprising or alternatively consisting of an alkyl chain of 4 or more carbon atoms or an aryl or aralkyl group comprising a benzene ring, and R′ and R″ each represent hydrogen or an alkyl group having 1 to 20 carbon atoms, a cycloalkyl group having 5 to 20 carbon atoms or a phenyl group, as a hydrophobing agent for a construction material or for a textile material or for a particulate filler.

This invention relates to organosilicon compounds used as hydrophobing agents, that is to render a substrate more hydrophobic. The invention also relates to a process for rendering a construction material or other substrate more hydrophobic by treatment with the organosilicon compounds, and to construction materials containing the organosilicon compounds. The invention also relates to an emulsion of the organosilicon compounds.

Alkylalkoxysilanes are known from U.S. Pat. No. 4,716,051 as hydrophobing agents for construction applications. For example isobutyltrimethoxysilane and n-octyltriethoxysilane have been used commercially for concrete protection or as active ingredients in masonry water repellents. They combine good hydrophobic properties due to the alkyl chain combined with reactivity of the alkoxy group. However alcohols are formed during the application which are volatile organic chemicals and can cause environmental, health and safety issues.

U.S. Pat. No. 5,074,912 and U.S. Pat. No. 5,086,146 describe a water repellent composition for treating porous substrates which is an emulsion including a copolymer such as a linear methylhydrogen-methylalkyl siloxane or a methylhydrogen-methylalkyl cyclosiloxane. Such SiH-containing siloxanes are reactive hydrophobing agents with can react with substrates or crosslink without the generating of alcohols, but they cannot penetrate well into porous substrates.

U.S. Pat. No. 6,331,329 describes forming a monolayer-modified metal surface by contacting a metal surface with a hydridosiloxane-containing polymer or with a hydridosilane.

According to one aspect of the present invention an organosilane having the formula

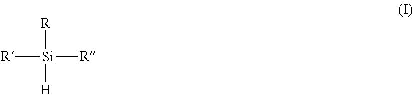

where R is an alkyl or cycloalkyl group having 4 to 30 carbon atoms comprising or alternatively consisting of an alkyl chain of 4 or more carbon atoms or an aryl or aralkyl group comprising or alternatively consisting of a benzene ring, and R′ and R″ each represent hydrogen or an alkyl group having 1 to 20 carbon atoms, a cycloalkyl group having 5 to 20 carbon atoms or a phenyl group, is used as a hydrophobing agent for a construction material.

For the avoidance of doubt it is to be understood that all references to the term organosilane(s) herein is/are referring to the organosilane depicted in Formula (I) above unless otherwise indicated.

We have found that construction materials such as concrete treated with such organosilanes show excellent hydrophobic properties with good depth of penetration of the organosilane hydrophobing agent into the substrates, while not releasing alcohols or other volatile organic chemicals during application.

According to another embodiment an organosilane of the formula (I) as defined above is used as a hydrophobing agent for a textile material.

According to a further embodiment an organosilane of the formula (I) as defined above is used as a hydrophobing agent for a particulate filler.

According to a further embodiment there is provided method for the preparation of hydrophobic materials comprising applying an organosilane, as depicted in formula (I) above, on to a construction material or a textile material or a particulate filler (to increase the hydrophobic nature of said respective construction material, textile material or particulate filler.

According to a still further embodiment there is provided a hydrophobing agent for a construction material or a textile material or a particulate filler comprising or consisting of an organosilane in accordance with Formula (I) above.

According to a still further embodiment there is provided a method of treating a construction material or a textile material or a particulate filler by applying a hydrophobing agent comprising or consisting of an organosilane in accordance with formula (I) above on to said construction material or a textile material or a particulate filler. In other words, there is provided a process for rendering a construction material more hydrophobic, wherein at least one surface of the construction material is treated with an organosilane of the formula (I) as defined above. The organosilane may be one component of a hydrophobic agent or the hydrophobic agent may consist of the organosilane.

According to a still further embodiment there is provided an oil-in water emulsion wherein the disperse oil phase is an alkylsilane or other organosilane of the formula (I) as defined above.

In the above formula (I), R is most preferably an alkyl group having 8 to 20 carbon atoms, for example an n-octyl, 2-ethylhexyl, decyl, lauryl or octadecyl group, but can alternatively be an n-butyl or n-hexyl group or a cyclohexyl or cyclohexylmethyl group. The term “alkyl chain of 4 or more carbon atoms” includes 4 or more alkylene units joined in a ring in a cycloalkyl group as an alternative to an open alkyl chain of 4 or more carbon atoms.

The group R can alternatively be a benzene ring containing group i.e. an aryl group, preferably a phenyl group, or an aralkyl group such as a benzyl or 2-phenylpropyl group.

Alkylsilanes (silylalkanes) in which the groups R′ and R″ each represent hydrogen, that is alkylsilanes (silylalkanes) of the formula RSiH₃, are particularly preferred. Examples of such alkylsilanes (silylalkanes) are n-octylsilane (C₈H₁₇SiH₃ otherwise known as, for example, silyl-n-octane) and octadecylsilane (C₁₈H₃₇SiH₃, otherwise known as silyloctadecane). Alkylsilanes (silylalkanes) in which R′ represents hydrogen and R″ represents an alkyl group (dihydroalkylsilylalkanes) are also preferred, particularly those in which R″ represents an alkyl group having 1 to 4 carbon atoms such as a methyl group.

The organosilane in accordance with the present invention can be used in admixture with a SiH-containing siloxane (i.e. a siloxane containing hydrogen directly attached to silicon), such as a linear methylhydrogen-methylalkyl siloxane copolymer or a methylhydrogen-methylalkyl cyclosiloxane. The mixture preferably contains less than 100%, more preferably less than 50%, by weight SiH-containing siloxane based on the weight of the organosilane present (i.e. the weight of the organosilane present is greater than that of SiH-containing siloxane present and alternatively the weight of the organosilane is present in an amount greater than double the weight of the SiH-containing siloxane) to achieve the desired depth of penetration of the organosilane hydrophobing agent into the substrate.

The organosilane in accordance with formula (I) having at least one hydrogen attached to silicon can be used in admixture with other secondary hydrophobing agents such as PDMS (polydimethylsiloxanes), silicon resin or wax. The secondary hydrophobing agent preferably does not release volatile organic compounds during the application. The other secondary hydrophobing agent(s) will generally not penetrate well into porous substrates but can provide surface beading of water as may be sometimes desired.

Examples of construction materials that can be treated according to the invention include masonry, concrete, concrete blocks, bricks, natural stone, fibre cement boards and gypsum boards. Application of a hydrophobing agent containing or consisting of the organosilane used herein is a convenient and effective treatment when applied as a post treatment to already formed construction materials. In the case of blocks or boards, the hydrophobing agent may be applied by mixing it with the construction material during the manufacturing of the construction products.

The organosilane can be applied to the construction material as an undiluted liquid organosilane or as an aqueous emulsion (oil-in-water emulsion) of organosilane. The organosilane can alternatively be applied from solution in a volatile organic solvent, but this negates the advantage that the organosilanes of the invention do not release volatile organic alcohols. In case the organosilane is applied from an organic solvent low VOC or VOC exempt solvents are preferred. When the organosilane is applied to the surface of a formed construction material such as a concrete block or stone block, it is preferably applied at 10 to 1000 g/m², or alternatively 50 to 500 g/m².

Aqueous emulsions wherein the disperse oil phase is an organosilane of the formula (I) as defined above can be prepared by blending the organosilane with an emulsifier and dispersing the blend in water. Said aqueous emulsions may be used as hydrophobing agents.

The emulsifier is a surfactant or mixture of surfactants having the ability to stabilize an aqueous emulsion. The surfactant may be an anionic surfactant, cationic surfactant, non-ionic surfactant, amphoteric surfactant, or a mixture of surfactants. Non-ionic surfactants and anionic surfactants are typically used and mixtures containing two non-ionic surfactants are also typically used.

Representative examples of suitable non-ionic surfactants include condensates of ethylene oxide with long chain fatty alcohols or fatty acids such as a C 12-16 alcohol, condensates of ethylene oxide with an amine or an amide, condensation products of ethylene and propylene oxide, esters of glycerol, sucrose, sorbitol, fatty acid alkylol amides, sucrose esters, fluoro-surfactants, and fatty amine oxides. Representative examples of suitable commercially available non-ionic surfactants include polyoxyethylene fatty alcohols sold under the trade name BRIJ by Uniqema (ICI Surfactants), Wilmington, Del. Some examples are BRIJ 35 Liquid, an ethoxylated alcohol known as polyoxyethylene (23) lauryl ether, and BRIJ 30, another ethoxylated alcohol known as polyoxyethylene (4) lauryl ether. Some additional non-ionic surfactants include ethoxylated alcohols sold under the trademark TERGITOL® by The Dow Chemical Company, Midland, Mich. Some example are TERGITOL(R) TMN-6, an ethoxylated alcohol known as ethoxylated trimethylnonanol; and various of the ethoxylated alcohols, i.e., C 12-C 4 secondary alcohol ethoxylates, sold under the trademarks TERGITOL®15-S-5, TERGITOL®15-S-12, TERGITOL®15-S-15, and TERGITOL®15-S-40. Surfactants containing silicon atoms can also be used. When mixtures containing non-ionic surfactants are used, one non-ionic surfactant should have a low Hydrophile-Lipophile Balance (HLB) and the other non-ionic surfactant should have a high HLB, such that the two non-ionic surfactants have a combined HLB of 11 -15, preferably a combined HLB of 12.5-14.5.

Representative examples of suitable anionic surfactants include alkali metal soaps of higher fatty acids, alkylaryl sulphonates such as sodium dodecyl benzene sulphonate, long chain fatty alcohol sulphates, olefin sulphates and olefin sulphonates, sulphated monoglyccrides, sulphated esters, sulphonated ethoxylated alcohols, sulphos[upsilon]ccinates, alkane sulphonates, phosphate esters, alkyl isethionates, alkyl taurates, and alkyl sarcosinatcs. One example of a preferred anionic surfactant is sold commercially under the name Bio-Soft N-300. It is a triethanolamine linear alkylate sulphonate composition marketed by the Stephan Company, Northfield, Ill.

Representative examples of suitable cationic surfactants include alkylamine salts, quaternary ammonium salts, sulphonium salts, and phosphonium salts. Representative examples of suitable amphoteric surfactants include imidazoline compounds, alkylamino acid salts, and betaines.

The emulsifier can for example be used at 1 to 20% by weight emulsifier based on the weight of the organosilane. For optimum stability the aqueous phase should have a slightly acid pH, for example pH 4 to pH 6.5. Buffer solutions can be used to stabilize the desired pH. The concentration of organosilane in accordance with the present invention in such an oil-in-water emulsion can be from 1 to 85% by weight or alternatively from 5 to 80% by weight but is more preferably for example between 10 and 80% by weight of the total composition. If a secondary hydrophobing agent such as a polysiloxane is present in the emulsion, the total concentration of organosilane plus secondary hydrophobing agent can for example be from about 10 up to 80% by weight of the total composition. The concentration of emulsifier in such an oil-in water emulsion can for example be between 0.5 and 10% by weight of the total composition. Water can for example be present at 10 to 89.5% by weight of the total composition. In each instance when referred to in % values the total present is 100% and the remainder of the emulsion is made up of other ingredients, typically water and surfactant(s) and optional additives to a value of 100%.

Emulsions of organosilane in accordance with Formula (I) can contain various additives known in silicone emulsions, for example fillers, colouring agents such as dyes or pigments, heat stabilizers, flame retardants, UV stabilizers, fungicides, biocides, thickeners, preservatives, antifoams, freeze thaw stabilizers, or inorganic salts to buffer pH. Such materials can be added to the organosilane before or after the organosilane has been emulsified.

The emulsion can be formulated to be in the form of a gel or creme. This can be done by using thickeners such as bentonite or montmorillonite in the emulsion or by having an active organosilane content of above 60% in the emulsion. Such cremes of high organosilane content can be formed by preparing a mobile aqueous emulsion from a minor part of the organosilane with all of the emulsifier and water and mixing the remaining organosilane into the emulsion using a colloid mill, a high speed stator and rotor stirrer, or a pressure emulsification unit.

The organosilane in accordance with the present invention can alternatively be used in the form of granules comprising the organosilane and a binder polymer deposited on a particulate carrier. The binder agglomerates carrier particles into larger granules, which for example can have a size between 20 and 1000 μm. Each granule is typically formed of carrier particles, organosilane and binder agglomerated or glued together in a single granule.

Granules are formed from a granulation process in which the organosilane and the binder are deposited in their liquid form onto carrier particles resulting in the preparation of a free flowing solid (granular) powder. A typical granulation method may comprise the steps of, optionally heating the organosilane component and a suitable binder to give a liquid material, either separately or in admixture, e.g. as a flowable slurry, which is then deposited onto the carrier particles, e.g. in a fluid bed, thus causing the organopolysiloxane component and binder in admixture to solidify, e.g. through cooling or through the evaporation of a solvent, onto the carrier particles and form a free flowing powder. The granulated hydrophobing additive may then be mixed in with the cementitious powder material and would form a stable dry composition which may easily be stored or transported in that form.

The binder polymer can for example be water- soluble, for example polyvinyl alcohol, carboxymethyl cellulose or a polycarboxylate such as polyacrylic acid, or water-insoluble but water-dispersible (emulsifiable), for example polyvinyl acetate, vinyl acetate ethylene copolymers, acrylate ester polymers or methyl cellulose. Blends of binder material as described above can be used, for example a blend of a water-soluble binder polymer such as polyvinyl alcohol with a water-insoluble binder polymer such as polyvinyl acetate. The binder polymer is generally solid at room temperature, i.e. from 20 to 25° C. The binder polymer can for example be dissolved or emulsified in an aqueous emulsion of the organosilane, applied to the carrier and dried.

The binder polymer can alternatively be a waxy material of melting point of 35 to 100° C., for example a polyol ester which is a polyol partially or fully esterified by carboxylate groups each having 7 to 36 carbon atoms such as glyceryl tristearate or glyceryl monostearate. The organosilane can be mixed with the waxy material and applied to the carrier particles when the waxy material is in a molten state, and the resulting treated particles can be agglomerated to granules by cooling to solidify the waxy material.

The carrier particles may be water-insoluble, water-soluble or water-dispersible. Suitable examples of carrier particles include aluminosilicates (such as zeolite or metakaolin), fly ash, clay materials, lime, calcium carbonates, starch, native starch, methyl cellulose, carboxy methyl cellulose, cement, sand polystyrene beads and polyacrylate beads. It is preferred that the carrier particles have a mean diameter of from 0.1 to 1000 μm, most preferably 0.2 to 50 μm. For use in construction materials it is preferred to use materials which fulfil a useful role in the construction material, for example in cement or concrete aluminosilicates or cement itself.

A granulated organosilane hydrophobing additive can be mixed into a cementitious material or other construction material by mechanical means or any other appropriate method. Mixing can conveniently be carried out by dry mixing the granulated hydrophobing additive with the cementitious material at the stage where is in a dry, powdery form. Alternatively the hydrophobing additives can be added during or after hydration of the cement, for example immediately prior to or during the process of applying the cementitious material to a substrate.

Examples of textile materials which can be treated as hereinbefore described include woven, knitted or nonwoven fabrics, textile fibres and any other product made from textile fibres such as polyester, polyamide, acrylic, cotton or wool fibres. The organosilane as hereinbefore described renders the textile material hydrophobic without release of volatile organic alcohols and with good penetration of the fabric. The organosilane can for example be applied to the fabric as an undiluted liquid organosilane or as an aqueous emulsion of organosilane.

Examples of particulate fillers which can be treated according to the invention include reinforcing fillers such as silica, silicic acid, carbon black, or a mineral oxide of aluminous type such as alumina trihydrate or an aluminium oxide-hydroxide, or a silicate such as an aluminosilicate, other mineral fillers such as talc, magnesium dihydroxide or calcium carbonate, or organic fillers such as starch. Treatment of the filler with an organosilane according to the invention renders it more hydrophobic and thus more compatible with hydrophobic matrices such as polyolefins. The particulate filler can be mixed with an undiluted liquid organosilane or as an aqueous emulsion of organosilane. The organosilane of the invention renders the filler hydrophobic without release of volatile organic alcohols. The organosilane penetrates well through a bulk filler powder so that the filler particles have a higher proportion of their surface hydrophobed, and are more uniformly hydrophobed, compared to a filler powder treated with a polymer such as a polysiloxane.

The invention is illustrated by the following Examples:

### EXAMPLES 1 TO 4

Concrete blocks (approx 6 cm by 6 cm by 4 cm thick) were treated with different amounts of alkylsilane as shown in Table 1 by brushing an undiluted alkylsilane in accordance with the present invention onto one surface of each block. In the case of the octadecylsilane the material was heated to 50° C. prior to the treatment since the molecule is a solid at room temperature. After the treatment the blocks were conditioned for 1 week at room temperature and 50-60% relative humidity.

TABLE 1

| Example | Treatment | Quantity |
|---|---|---|
| 1 | n-octylsilane (C₈H₁₇SiH₃) | 100 g/m² |
| 2 | n-octylsilane (C₈H₁₇SiH₃) | 200 g/m² |
| 3 | n-octadecylsilane(C₁₈H₃₇SiH₃) | 100 g/m² |
| 4 | n-octadecylsilane (C₁₈H₃₇SiH₃) | 200 g/m² |

The depth of penetration of the alkylsilane into the concrete was measured by splitting the treated concrete perpendicularly to the treated surface and treating the split surface with a water-based blue ink. The non-treated core of the block became blue but the surface layer which the alkylsilane had penetrated was not coloured by the ink. The thickness of this surface layer which the alkylsilane had penetrated i.e. the depth of penetration (DOP) was measured and the depth of penetration (DOP) is shown in Table 2.

TABLE 2

| Example | DOP mm |
|---|---|
| 1 | 5 |
| 2 | 7 |
| 3 | 3 |
| 4 | 3 |

Table 2 shows that the depth of penetration of the alkylsilane into the concrete can be several millimetres. This high depth of penetration indicates that the alkylsilane can give durable long term protection.

The water absorption of the treated concrete blocks over time was measured by the RILEM (Reunion Internationale des Laboratoires d′Essais et de Recherchessur les Materiaux et les Constructions) test 11.4 (horizontal version), which is designed to measure the quantity of water absorbed by the surface (5 cm² exposed surface) of a masonry material over a defined period of time. The water absorption in ml. of each block after various times is given in Table 3. An untreated concrete block was used as a reference (‘ref’). The values in the table are ml of water absorbed.

TABLE 3

| Exam- | | | | | | |
|---|---|---|---|---|---|---|
| ple | 30 minutes | 1 hour | 2 hours | 4 hours | 8 hours | 24 hours |
| 1 | 0 | 0.05 | 0.1 | 0.1 | 0.1 | 0.3 |
| 2 | 0.05 | 0.1 | 0.15 | 0.2 | 0.3 | 0.7 |
| 3 | 0 | 0 | 0 | 0.05 | 0.05 | 0.15 |
| 4 | 0 | 0 | 0 | 0 | 0 | 0.05 |
| ref | 2.3 | 3.9 | >4 | >4 | >4 | >4 |

Table 3 shows that excellent water exclusion is obtained by alkylsilane treatment according to the invention even for extended (prolonged) periods of time. The water absorption of the blocks treated in Examples 1 to 4 after 24 hours water immersion is very much less than that of an untreated block after only 30 minutes immersion.

### EXAMPLES 5 A AND B

An aqueous surfactant solution containing two non-ionic surfactants was prepared by adding 1,21 g Volpo L23 and 1.27 g Volpo L4 to 57.69 g of water at about 40° C.

### a) Preparation of Example 5a

To 10.14 g of the surfactant solution 2.00 g of n-octadecylsilane were added and emulsified with an Ultrasound probe (Sonifier, 2 minutes at 30% output). A white emulsion was obtained which showed no signs of separation after standing for at least 4 weeks at room temperature. The emulsion had a particle size (obtained with a Malvern Mastersizer in volume mode) of:
d(0.1)=0.109 μm
d(0.5)=0.258 μm
d(0.9)=0.658 μm;

### b) Preparation of Example 5b

To 10.13 g of the surfactant solution 2.08 g of n-octylsilane were added and emulsified with an Ultrasound probe (Sonifier, 2 minutes at 30% output). A white emulsion was obtained which showed no signs of separation after standing at least 4 weeks at room temperature. The emulsion had a particle size (obtained with a Malvern Mastersizer in volume mode) of:
d(0.1)=0.075 μm
d(0.5)=0.163 μm
d(0.9)=0.433 μm;

Concrete blocks (10 cm*10 cm*4 cm) were treated by applying 2 g of the emulsion to one surface of each block The concrete blocks were allowed to dry for 4 weeks at room temperature (RT) and their water uptake was tested using the Rilem method described above.

TABLE 4

| Exam- | | | | | | |
|---|---|---|---|---|---|---|
| ple | 30 minutes | 1 hour | 2 hours | 4 hours | 8 hours | 24 hours |
| 5a | 0 | 0 | 0.1 | 0.2 | 0.3 | 0.9 |
| 5b | 0.2 | 0.2 | 0.4 | 0.6 | 0.8 | 1.8 |

The values in the table are ml of water absorbed.

Table 4 shows the treatment with emulsions according to the invention strongly reduces the water uptake of concrete when compared with the reference in table 3 (same concrete).

1-5. (canceled)

6. A process for rendering a construction material more hydrophobic, wherein at least one surface of the construction material is treated with an oil-in-water emulsion comprising an organosilane having the formula 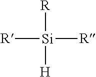
where R is an alkyl or cycloalkyl group having 4 to 30 carbon atoms comprising or alternatively consisting of an alkyl chain of 4 or more carbon atoms or an aryl or aralkyl group comprising or a benzene ring, and R′ and R″ each represent hydrogen or an alkyl group having 1 to 20 carbon atoms, a cycloalkyl group having 5 to 20 carbon atoms or a phenyl group.

7. A process according to claim 6, characterised in that the organosilane is applied at 50 to 500 g/m².

8. (canceled)

9. A process according to claim 6, characterised in that the organosilane is applied by brush, spray or roller.

10. A process according to claim 6, characterised in that the organosilane is an alkylsilane of the formula RSiH₃ wherein R is an alkyl group having 8 to 20 carbon atoms.

11. An oil-in-water emulsion characterised in that the disperse oil phase is an organosilane of the formula 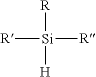
where R is an alkyl or cycloalkyl group having 4 to 30 carbon atoms comprising or alternatively consisting of an alkyl chain of 4 or more carbon atoms or an aryl or aralkyl group comprising a benzene ring, and R′ and R″ each represent hydrogen or an alkyl group having 1 to 20 carbon atoms, a cycloalkyl group having 5 to 20 carbon atoms or a phenyl group.

12. An oil-in-water emulsion according to claim 11, characterised in that the organosilane is of the formula RSiH₃.

13. (canceled)

14. A process for rendering a textile material or particulate filler more hydrophobic, wherein the textile material or particulate filler is respectively treated with the oil-in-water emulsion of claim 11.

15. (canceled)

16. An oil-in-water hydrophobing agent for a construction material or a textile material or a particulate filler comprising an organosilane having the formula 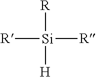
where R is an alkyl or cycloalkyl group having 4 to 30 carbon atoms comprising or alternatively consisting of an alkyl chain of 4 or more carbon atoms or an aryl or aralkyl group comprising a benzene ring, and R′ and R″ each represent hydrogen or an alkyl group having 1 to 20 carbon atoms, a cycloalkyl group having 5 to 20 carbon atoms or a phenyl group.

17. A method of treating a construction material or a textile material or a particulate filler comprising applying a hydrophobing agent comprising the oil-in-water emulsion of claim 11.

18. An oil-in-water emulsion according to claim 11, characterised in that R is an alkyl group having 8 to 20 carbon atoms.

19. An oil-in-water emulsion according to claim 11, characterised in that R′ represents hydrogen and R″ represents an alkyl group, or R′ and R″ both represent hydrogen.

20. An oil-in-water emulsion according to claim 11, characterised in that the organosilane is an alkylsilane of the formula RSiH₃ wherein R is an alkyl group having 8 to 20 carbon atoms.

21. A method for preparing an oil-in-water emulsion in accordance with claim 11 by blending the organosilane with an emulsifier and dispersing the blend in water.
